(19) United States
(12) Patent Application Publication
(10) Pub. No.: US 2016/0363279 A1
(43) Pub. Date: Dec. 15, 2016

(54) STRUCTURE OF A LIGHTING DISPLAY DEVICE

(71) Applicant: SU-FANG HO, NEW TAIPEI CITY 236 (TW)

(72) Inventor: SU-FANG HO, NEW TAIPEI CITY 236 (TW)

(21) Appl. No.: 14/735,238

(22) Filed: Jun. 10, 2015

(51) Int. Cl. F21S 10/00; F21V 7/00; F21V 23/00

(52) U.S. Cl. CPC F21S 10/002; F21V 23/002; F21V 7/0033; F21V 23/009

(57) ABSTRACT

An improved structure of a lighting display device includes a base and a supporting bracket mounted on the base. The supporting bracket has an engaging element at the top to combine with a positioning element; the positioning element has a linking tool arranged aside to link to the engaging element, making the positioning element having the same axis as a mounting seat mounted on the base which is perpendicular to the base. The positioning element is detachable from the supporting bracket for replacing and fixing the position of the lighting object of the present invention.

### BACKGROUND OF THE INVENTION

1. Field of the Invention

The present invention relates to an improved structure of a lighting display device, particularly to one that can replace a lighting object thereof and stably fix the position of the lighting object.

2. Description of the Related Art

A lava lamp display device disclosed in U.S. Pat. No. 3,570,156 comprises a glass vessel having a bottom arranged in a hollow conical metallic seating and located on an electric light bulb. Moreover, the glass vessel has two immiscible components, for example, liquid and paraffin. Paraffin has a higher density than liquid at room temperature and a lower density after heating. After the electric light bulb is turned on, the paraffin at the bottom of the glass vessel is heated and flows in the liquid. At the same time, the electric light bulb projects the light to the glass vessel, forming a lighting effect which becomes a decoration at homes and offices. In addition, if the liquid has a plurality of glitters as contents, the glitters would move and flow with the liquid; such application is called a glitter lamp. However, the lava lamp display device or the glitter lamp only has lighting effects in a single glass vessel. As a decoration, it seems to be monotonous and lacking of visual effects.

Therefore, the inventor has disclosed a lighting object disposed in a frame body with a window at the front that would display an inward serial arrangement of lights and moving shadows from the middle with non-parallel reflection surfaces being repeatedly reflected, creating a mixed feature combining a lighting fixture with an artificial decoration with special visual effects. However, there is only a front window displaying the visual effects of lights and moving shadows, which confines the visual area for the audience; and the transparent bottle as the lighting object needs to be maintained and replaced regularly, which would cause inconveniences for the users as well, leaving the invention to be improved.

### SUMMARY OF THE INVENTION

A primary object of the present invention is to provide an improved structure of a lighting display device that can replace a lighting object thereof and stably fix the position of the lighting object.

To achieve the objects mentioned above, the present invention comprises a base; a mounting seat perpendicularly arranged on the base with the top thereof having an opening; a circuit module disposed in the mounting seat as the lighting source and the heating source; a lighting object formed by a light-emitting transparent bottle with a top and a bottom, the bottom thereof being disposed on the opening of the mounting seat; and a supporting bracket having the foot thereof disposed on the base; wherein an engaging element is arranged at the top of the supporting bracket to engage a positioning element; the positioning element is connecting a linking tool aside and the bottom end of the linking tool is mounted on the engaging element so that the positioning element and the mounting seat are arranged on the same axis perpendicular to the base; the positioning element is detachable from the supporting bracket for placing the lighting object on the mounting seat and fixing the position thereof

In a preferred embodiment, the linking tool may be arranged in an L shape with an end thereof linking to the positioning element and the other end thereof being mounted on the engaging element, and the linking tool and the engaging element each has a positioning hole arranged at the corresponding position to each other, and the positioning holes are fixed in position by a screw or a bolt.

In an embodiment, the lighting object is a lava lamp or a glitter lamp, and the transparent bottle thereof is filled with heat-sensitive liquid that would flow around when receiving heat; near the top of the transparent bottle an engaging portion with a diameter less than the one of the transparent bottle is arranged, and a top end with a much less diameter than the one of the engaging portion is arranged at the top of the transparent bottle; the bottom of the transparent bottle has an inserting section with a diameter less than the one of the transparent bottle to be mounted on the mounting seat. The inner edge of the positioning element is arranged in a shape to be mounted on and fix the engaging portion of the transparent bottle; or it can be arranged in a shape to be mounted on and fix the top end of the transparent bottle in another embodiment.

In an embodiment, the positioning element has a lighting source disposed atop, and the supporting bracket is hollow for a stretchable wire to pass through; the stretchable wire is connected to the lighting source above the positioning element and to a power supply as well, so as to provide electricity for the lighting source. The present invention further includes a body disposed on the base with an opening arranged atop, including: a light-transmitting front surface; a rear surface; a film-coated glass arranged on the front surface with the front of the film-coated glass being light-transmitting and the back being reflective, forming a window at the front of the body; and a first reflection mirror and a second reflection mirror being fixed on the rear surface of the body behind the transparent bottle and having the reflection surfaces facing towards the transparent bottle.

With the features stated, the body further includes a first bottom surface having a first through hole arranged thereon, and the mounting seat includes a second bottom surface having a second through hole arrange thereon, corresponding to the first through hole; the base has a third through hole corresponding to the first and second through hole; the circuit module has a heat dissipating element, at the bottom of which a threaded hole is arranged to engage an upper section of a hollow bolt; the hollow bolt further has an abutting portion arranged above a lower section thereof for abutting on the base as the lower section being engaged through the first, second, and third through holes, then fixed on the base by a nut, so that the mounting seat and the body are fixed on the base, and an electric wire is able to pass through the base and connect to the circuit module for electricity supply.

As structures disclosed above, the present invention has a detachable positioning element for replacement of the lighting object and stably fixing the position of it. Also, the body has surrounding surfaces to increase the visual area by having the surfaces on both sides projecting the lights and moving shadows of the contents in the lighting object, enriching the visual effects and making it easier for replacement and maintenance.

### BRIEF DESCRIPTION OF THE DRAWINGS

FIG. 1 is an exploded view of the present invention viewing from the back at an oblique angle;

FIG. 2 is a perspective view of the present invention viewing from the back at an oblique angle;

FIG. 3 is a perspective view of the present invention viewing from the front at an oblique angle;

FIG. 4 is a front sectional view of the present invention;

FIG. 5 is a sectional view along line 5-5 in FIG. 4;

FIG. 6 is a sectional view along line 6-6 in FIG. 4;

FIG. 7A is a schematic diagram illustrating the positioning element being detached from the supporting bracket;

FIG. 7B is a schematic diagram illustrating the positioning element being removed upwards and turned away from the supporting bracket; and

FIG. 8 is a sectional view of the present invention in an application embodiment.

### DETAILED DESCRIPTION OF THE PREFERRED EMBODIMENT

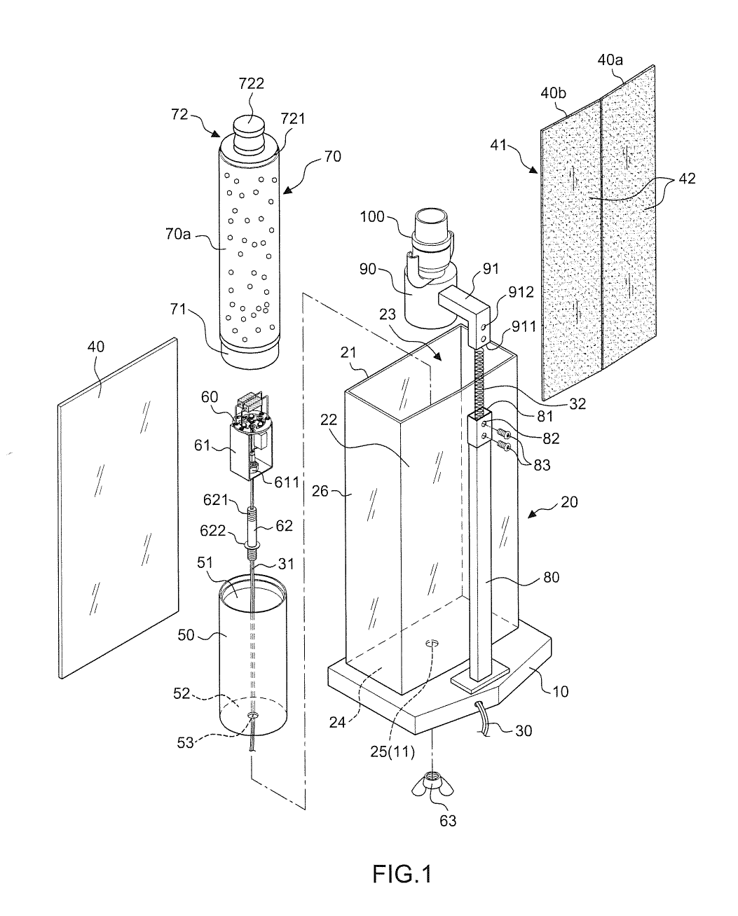

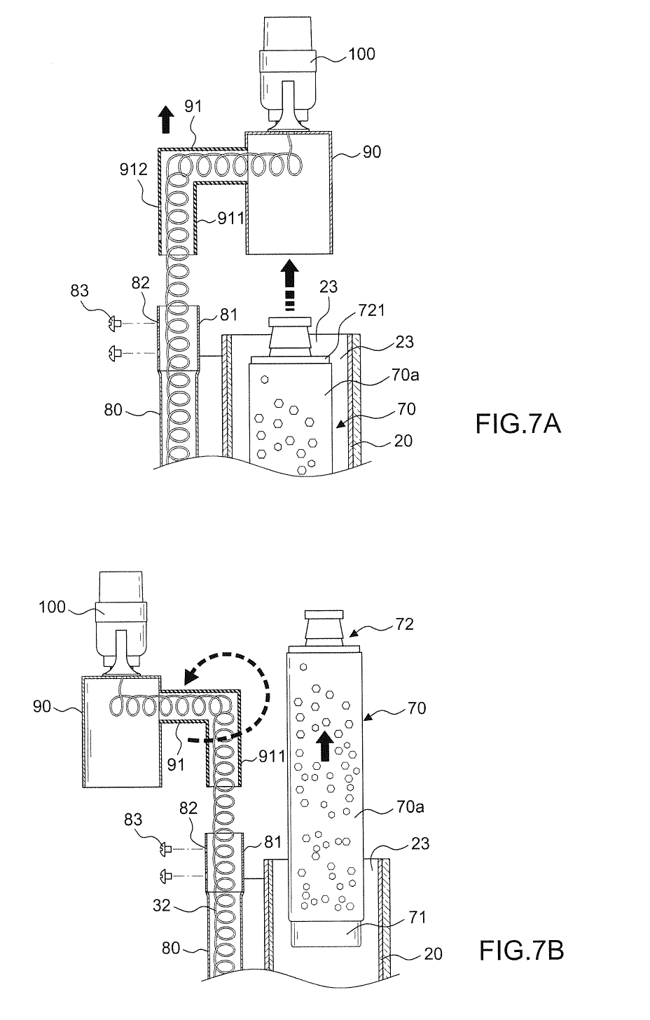

Referring to FIGS. 1-7, in a preferred embodiment, the present invention comprises a base 10, a body 20, a film-coated glass 40, a mounting seat 50, a lighting object 70, a first reflection mirror 40a, a second reflection mirror 40b, and a supporting bracket 80.

The body 20 is disposed on the base 10 with an opening 23 arranged atop, including a light-transmitting front surface 21, a rear surface 22, a film-coated glass 40 arranged on the front surface 21 with the front of the film-coated glass 40 being light-transmitting and the back being reflective, forming a window at the front of the body 20.

The mounting seat 50 is perpendicularly arranged on the base 10 with the top thereof having an opening 51; the circuit module 60 is disposed in the mounting seat 50 as lighting and heating source.

The lighting object 70 is formed by a light-emitting transparent bottle 70a with a top 72 and a bottom 71; the bottom 71 thereof is mounted on the opening 51 of the mounting seat 50.

The first reflection mirror 40a and the second reflection mirror 40b are fixed on the rear surface 22 of the body 20 behind the transparent bottle 70a, and have two reflection surfaces 41 of the reflection mirrors 40a, 40b facing towards the transparent bottle 70a. The supporting bracket 80 has the foot thereof disposed on the base 10.

The lighting object 70 is a lava lamp or a glitter lamp, and the transparent bottle 70a thereof is filled with heat-sensitive liquid that would flow around when receiving heat; near the top 72 of the transparent bottle 70a an engaging portion 721 with a diameter less than the one of the transparent bottle 70a is arranged, and a top end 722 with a much less diameter than the one of the engaging portion 721 is arranged at the top 72 of the transparent bottle; the bottom 71 of the transparent bottle 70a has an inserting section with a diameter less than the one of the transparent bottle 70a to be mounted on the mounting seat 50. Such structure has been disclosed in U.S. Pat. No. 8,911,101 patented by the inventor.

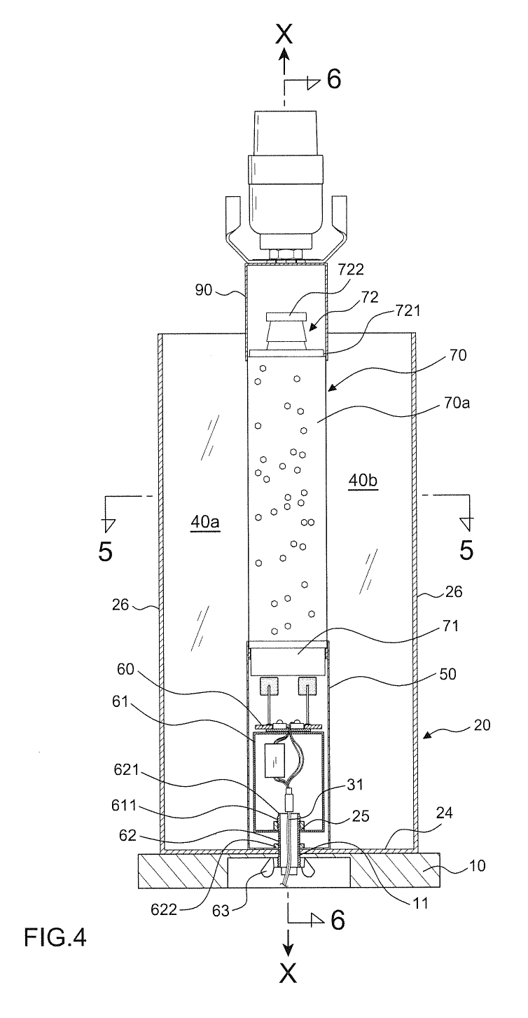

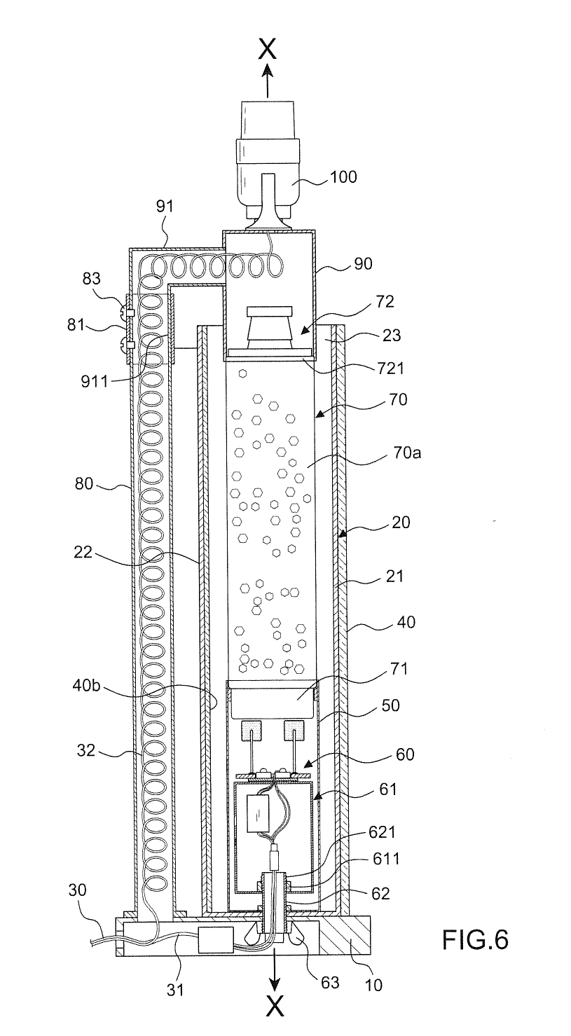

The features of the present invention lies in an engaging element 81 being arranged at the top of the supporting bracket 80 to engage a positioning element 90; the positioning element 90 con fleeting a linking tool 91 aside and the bottom end 911 of the linking tool 91 being mounted on the engaging element 81 for the positioning element 90 and the mounting seat 50 to be arranged on the same axis X-X perpendicular to the base 10 as shown in FIGS. 4 and 6; and the positioning element 90 being detachable from the supporting bracket 80 for placing the lighting object 70 vertically on the mounting seat 50 and fixing the position of the lighting object 70.

In this embodiment, the linking tool 91 is arranged in an L shape with an end thereof linking to the positioning element 90 and the other end thereof being mounted on the engaging element 81; the linking tool 91 and the engaging element 81 each has a positioning hole 912, 82 arranged at the corresponding position to each other, and the positioning holes 912, 82 are fixed in position by a screw 83 or a bolt. Furthermore, the inner edge of the positioning element 90 is arranged in a shape to be mounted on and fix the engaging portion 721 of the transparent bottle 70a.

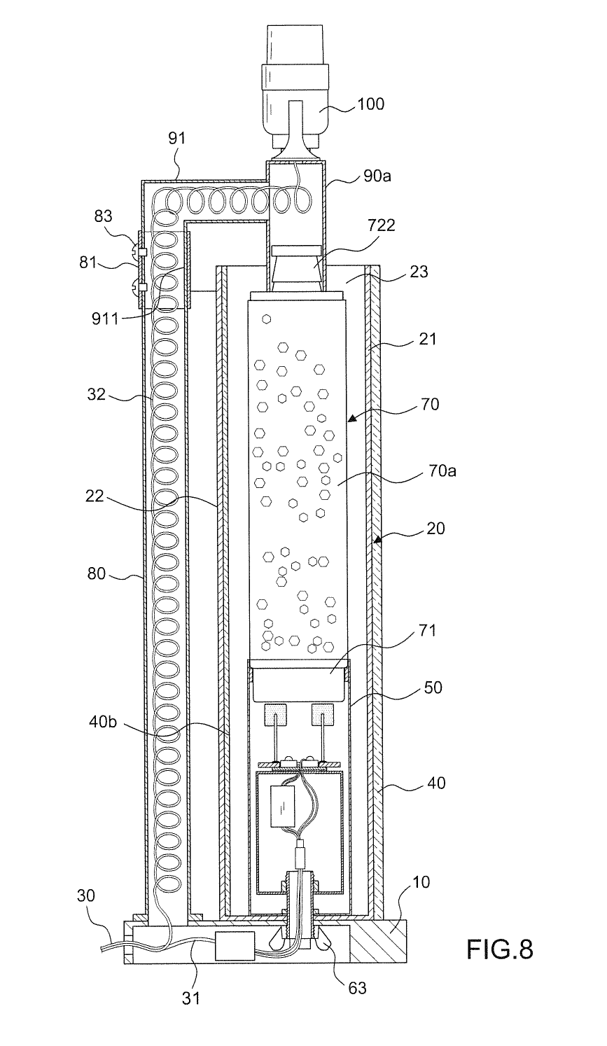

Referring to FIG. 8, in another applicable embodiment, the inner edge of the positioning element 90 is arranged in a much smaller shape to be mounted on and fix the top end 722 of the transparent bottle 70a. With such design, the transparent bottle 70a of the present invention would also be fixed and mounted on the mounting seat 50 as stably as when the positioning element 90 being mounted on the engaging portion 721 of the transparent bottle 70a.

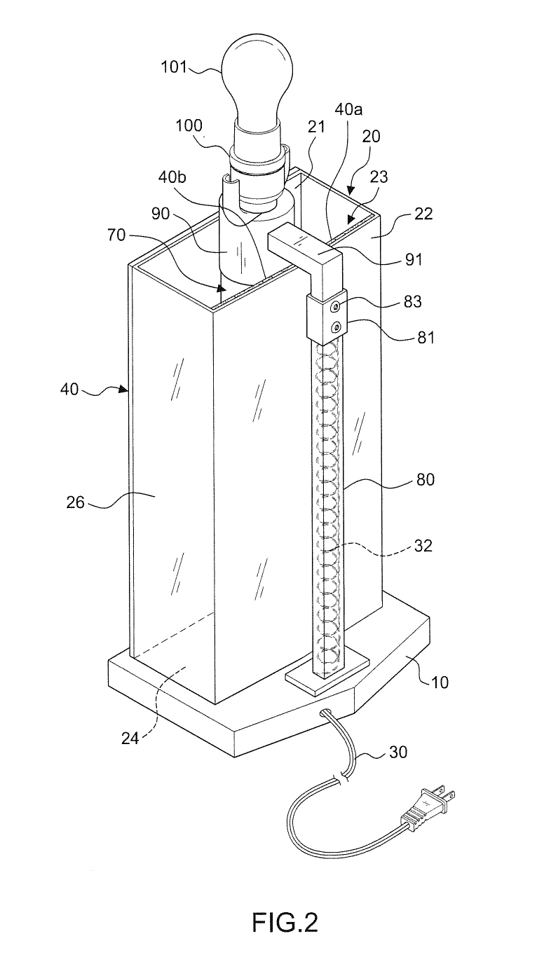

In this embodiment, the positioning element 90 has a lighting source 100 disposed at the top thereof, and the supporting bracket 80 is hollow for a stretchable wire 32 to pass through. The stretchable wire 32 is connected to the lighting source 100 above the positioning element 90 and to a power supply 30 as well, so as to provide electricity for the lighting source 100. Further referring to FIG. 2, the lighting source 100 may be a bulb 101 with a lampshade (not shown) disposed around the bulb 101.

Referring to FIGS. 1, 4 and 6, in the embodiment the body 20 further includes a first bottom surface 24 having a first through hole 25 arranged thereon, and the mounting seat 50 includes a second bottom surface 52 having a second through hole 53 arrange thereon, corresponding to the first through hole 25; the base 10 has a third through hole 11 corresponding to the first and second through hole 25, 53; the circuit module 60 has a heat dissipating element 61, at the bottom of which a threaded hole 611 is arranged to engage an upper section 621 of a hollow bolt 62; the hollow bolt 62 further has an abutting portion 622 arranged above a lower section thereof for abutting on the base 10 as the lower section being engaged through the first, second, and third through hole 25, 53, 11, then fixed on the base 10 by a nut 63, so that the mounting seat 50 and the body 20 are fixed on the base 10, and an electric wire 31 connected to the power supply 30 is able to pass through the base 10 and connect to the circuit module 60 for electricity supply.

In addition, the first reflection mirror 40a and the second reflection mirror 40b are fixed on the rear surface 22 of the body 20 behind the transparent bottle 70a and a layer of reflector 42 is spread on the back thereof; the front thereof are the reflection surfaces 41 facing towards the transparent bottle 70a. The first reflection mirror 40a and the second reflection mirror 40b have a center thereof serving as a reference to define a symmetrical arrangement where the first and second reflection mirror 40a, 40b are arranged inclined to form an angle θ between 145° and 175°, so that the transparent bottle 70a would display an unlimited extension of an inward serial arrangement from the middle when the moving shadows of the contents therein are reflected repeatedly and cumulatively by the first and second reflection mirror 40a, 40b. The structure was also disclosed in a prior patent applications by the inventor.

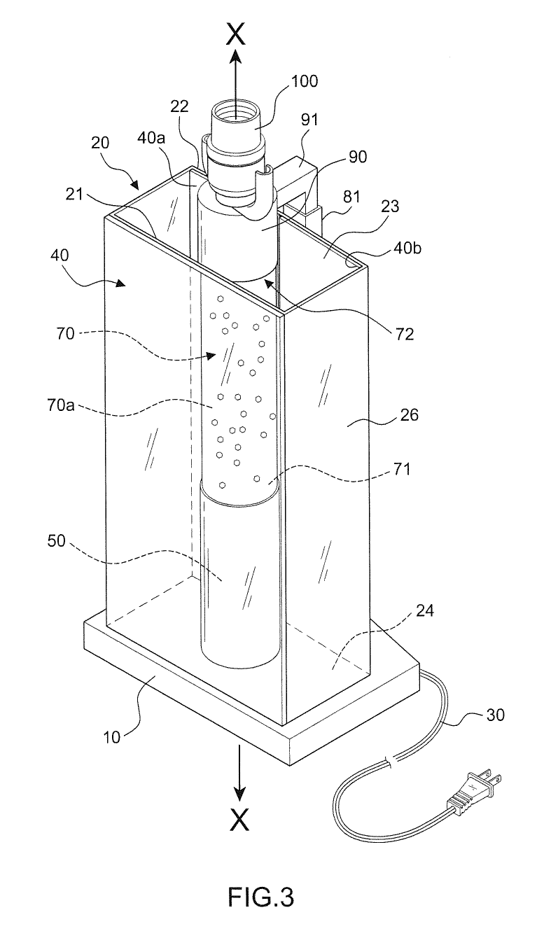

In this embodiment, the body 20 is a rectangle box with the opening 23 arranged atop for the first and second reflection mirror 40a, 40b to be fixed on the inner surface of the body 20, protecting them from damages by collisions or external impacts. The body 20 can be made of acrylic which is hard enough and light-transmitting, so that the film-coated glass 40 can be arranged on the front surface 21 of the body 20 without affecting transmittance of lights. Further referring to FIG. 3, the body 20 has surrounding surfaces to increase visual area and has the surfaces on both sides projecting the lights and moving shadows 442 of the glitters 44 inside the lighting object 40, enriching the visual effects.

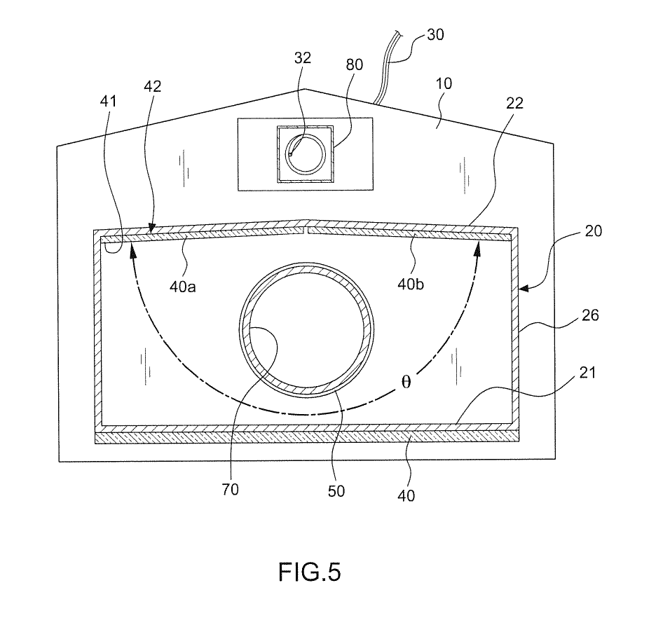

With reference to FIG. 5, the first and second mirror 40a, 40b on the rear surface 22 of the body 20 form an angle θ and have two symmetrical inclined surfaces to form a pre-determined slope when they are joined together.

With structures disclosed above, the present invention has the positioning element 50 detachable from the supporting bracket 80 for replacement of the lighting object and stably fixing the position of it. Also, the body 20 has surrounding surfaces to increase the visual area by having the surfaces on both sides projecting the lights and moving shadows of the contents in the lighting object 40, enriching the visual effects and making it easier for replacement and maintenance.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An improved structure of a lighting display device, comprising:
a base;
a mounting seat perpendicularly arranged on the base with the top thereof having an opening;
a circuit module disposed in the mounting seat as the lighting source and the heating source;
a lighting object formed by a light-emitting transparent bottle with a top and a bottom, the bottom thereof being disposed on the opening of the mounting seat; and
a supporting bracket having the foot thereof disposed on the base;
wherein an engaging element is arranged at the top of the supporting bracket to engage a positioning element; the positioning element is connecting a linking tool aside and the bottom end of the linking tool is mounted on the engaging element so that the positioning element and the mounting seat are arranged on the same axis perpendicular to the base; the positioning element is detachable from the supporting bracket for placing the lighting object on the mounting seat and fixing the position thereof.

2. The improved structure of a lighting display device as claimed in claim 1, wherein the linking tool is arranged in an L shape with an end thereof linking to the positioning element and the other end thereof being mounted on the engaging element.

3. The improved structure of a lighting display device as claimed in claim 2, wherein the linking tool and the engaging element each has a positioning hole arranged at the corresponding position to each other, and the positioning holes are fixed in position by a screw or a bolt.

4. The improved structure of a lighting display device as claimed in claim 1, wherein the lighting object is a lava lamp or a glitter lamp, and the transparent bottle thereof is filled with heat-sensitive liquid that would flow around when receiving heat; near the top of the transparent bottle an engaging portion with a diameter less than the one of the transparent bottle is arranged, and a top end with a much less diameter than the one of the engaging portion is arranged at the top of the transparent bottle; the bottom of the transparent bottle has an inserting section with a diameter less than the one of the transparent bottle to be mounted on the mounting seat.

5. The improved structure of a lighting display device as claimed in claim 4, wherein the inner edge of the positioning element is arranged in a shape to be mounted on and fix the engaging portion of the transparent bottle.

6. The improved structure of a lighting display device as claimed in claim 4, wherein the inner edge of the positioning element is arranged in a shape to be mounted on and fix the top end of the transparent bottle.

7. The improved structure of a lighting display device as claimed in claim 1, wherein the positioning element has a lighting source disposed at the top, and the supporting bracket is hollow for a stretchable wire to pass through; the stretchable wire is connected to the lighting source above the positioning element and to a power supply so as to provide electricity for the lighting source.

8. The improved structure of a lighting display device as claimed in claim 1, wherein the present invention further includes a body disposed on the base with an opening arranged atop, including:
a light-transmitting front surface;
a rear surface;
a film-coated glass arranged on the front surface with the front of the film-coated glass being light-transmitting and the back being reflective, forming a window at the front of the body; and
a first reflection mirror and a second reflection mirror being fixed on the rear surface of the body behind the transparent bottle, and having the reflection surfaces facing towards the transparent bottle.

9. The improved structure of a lighting display device as claimed in claim 8, wherein the body further includes a first bottom surface having a first through hole arranged thereon, and the mounting seat includes a second bottom surface having a second through hole arrange thereon, corresponding to the first through hole; the base has a third through hole corresponding to the first and second through holes; the circuit module has a heat dissipating element, at the bottom of which a threaded hole is arranged to engage an upper section of a hollow bolt; the hollow bolt further has an abutting portion arranged above a lower section thereof for abutting on the base as the lower section being engaged through the first, second, and third through holes, then fixed on the base by a nut, so that the mounting seat and the body are fixed on the base, and an electric wire is able to pass through the base and connect to the circuit module for electricity supply.

10. The improved structure of a lighting display device as claimed in claim 1, wherein the first reflection mirror and the second reflection mirror have a center thereof serving as a reference to define a symmetrical arrangement of the first and second reflection mirrors, which are arranged inclined to form an angle θ between 145°and 175°, so that the transparent bottle would display an unlimited extension of an inward serial arrangement from the middle when the moving shadows of the con tents in the transparent bottle are reflected repeatedly and cumulatively by the first and second reflection mirrors.

11. The improved structure of a lighting display device as claimed in claim 10, wherein the first and second mirrors on the rear surface form an angle θ and have two symmetrical inclined surfaces to form a pre-determined slope when they are joined together.
